(19) United States
(12) Patent Application Publication
(10) Pub. No.: US 2018/0123745 A1
(43) Pub. Date: May 3, 2018

(54) WIRELESS COMMUNICATION METHOD, DEVICE AND SYSTEM

(71) Applicant: INDUSTRIAL TECHNOLOGY RESEARCH INSTITUTE, Hsinchu (TW)

(72) Inventors: Hua-Lung Tsai, Taipei City (TW); Shin-Lin Shieh, Zhubei City (TW)

(73) Assignee: INDUSTRIAL TECHNOLOGY RESEARCH INSTITUTE, Hsinchu (TW)

(21) Appl. No.: 15/656,709

(22) Filed: Jul. 21, 2017

Related U.S. Application Data
(60) Provisional application No. 62/413,999, filed on Oct. 28, 2016.

(30) Foreign Application Priority Data
Dec. 13, 2016 (TW) 105141244

(51) Int. Cl. H04L 1/18; H04L 5/00

(52) U.S. Cl. CPC H04L 1/1887; H04L 1/189; H04L 5/0055

(57) ABSTRACT

Provided is a wireless communication method. Original packet data is generated based on transmission data. The original packet data is transmitted. A first cyclic shift operation is performed on the original packet data to generate a first shifted data. An EXOR logic operation is performed on the original packet data and the first shifted data to generate a first retransmission packet data. The first retransmission packet data is transmitted.

### CROSS-REFERENCE TO RELATED ART

This application claims the benefit of a prior-filed U.S. provisional application Ser. No. 62/413,999, filed Oct. 28, 2016, and the benefit of Taiwan application Serial No. 105141244, filed Dec. 13, 2016, the subject matters of which are incorporated herein by references

### TECHNICAL FIELD

The disclosure relates in general to a wireless communication method, device and system.

### BACKGROUND

During wireless transmission, transmission of data packets may be affected by factors such as the decay in time-variant channel or multipath and thus data packets may not be successfully received by the receiving end. To resolve such problem, various techniques are provided.

The automatic repeat request (ARQ) technique can be used to increase the chance of successfully transmitting data. In the ARQ technique, if the receiving end receives data successfully, then the receiving end returns an “acknowledgement” (ACK) signal to the transmitting end to confirm that data transmission is successful. Conversely, if the receiving end does not receive data successfully (that is, transmission failure), then the receiving end returns a “negative acknowledgement” signal (NACK) to notify the transmitting end that reception fails and the transmitting end needs to retransmit the data. Thus, the chance of successfully receiving data by the receiving end is increased.

The ARQ technique includes a stop-and-wait ARQ mechanism. In the stop-and-wait ARQ mechanism, the transmitting end will pause after transmitting a data packet. If the transmitting end receives an “acknowledgement” signal or a “negative acknowledgement” signal (NACK) from the receiving end or if the transmitting end does not receive any “acknowledgement” signal or any “negative acknowledgement” signal (NACK) from the receiving end over a predetermined time, then the transmitting end will transmit a new data or will retransmit the original data.

The hybrid automatic repeat request (HARQ) technique uses multiple stop-and-wait ARQ mechanisms operated in parallel to achieve a high efficient retransmission mechanism.

The disclosure provides a wireless communication method, device and system using HARQ.

### SUMMARY

According to one embodiment, a wireless communication method is provided. An original packet data is generated according to a to-be-transmitted data. The original packet data is transmitted. A first cyclic shift operation is performed on the original packet data to generate a first shifted data. An EXOR logic operation is performed on the original packet data and the first shifted data to generate a first retransmission packet data. The first retransmission packet data is transmitted.

According to another embodiment, a wireless communication device is provided. The wireless communication device includes: a bit register, a processing unit and a transceiver. The bit register temporarily stores a to-be-transmitted data. The processing unit generates an original packet data according to a to-be-transmitted data, performs a first cyclic shift operation on the original packet data to generate a first shifted data, and performs an EXOR logic operation on the original packet data and the first shifted data to generate a first retransmission packet data. The transceiver transmits the original packet data and the first retransmission packet data.

According to an alternate embodiment of the disclosure, a wireless communication system is provided. The wireless communication system includes a transmitting end device and a receiving end device. The transmitting end device includes a bit register for temporarily storing a to-be-transmitted data. The transmitting end device generates an original packet data according to the to-be-transmitted data, performs a first cyclic shift operation on the original packet data to generate a first shifted data, performs an EXOR logic operation on the original packet data and the first shifted data to generate a first retransmission packet data, and transmits the original packet data and the first retransmission packet data. The receiving end device, wirelessly communicates with the transmitting end device, receives the original packet data and the first retransmission packet data.

The above and other contents of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 is a functional block diagram of a wireless communication device according to an embodiment of the disclosure.

FIG. 2 is a flowchart of a wireless communication method of according to an embodiment of the disclosure.

FIG. 3 is a flowchart of a wireless communication method of according to an embodiment of the disclosure.

FIG. 4 is a flowchart of a wireless communication method of according to an embodiment of the disclosure.

FIG. 5 is a flowchart of a wireless communication method of according to an embodiment of the disclosure.

### DETAILED DESCRIPTION

Technical terms are used in the specification with reference to generally-known terminologies used in the technology field. For any terms described or defined in the specification, the descriptions and definitions in the specification shall prevail. Each embodiment of the disclosure has one or more technical characteristics. Given that each embodiment is implementable, a person ordinarily skilled in the art can selectively implement or combine some or all of the technical characteristics of any embodiment of the disclosure.

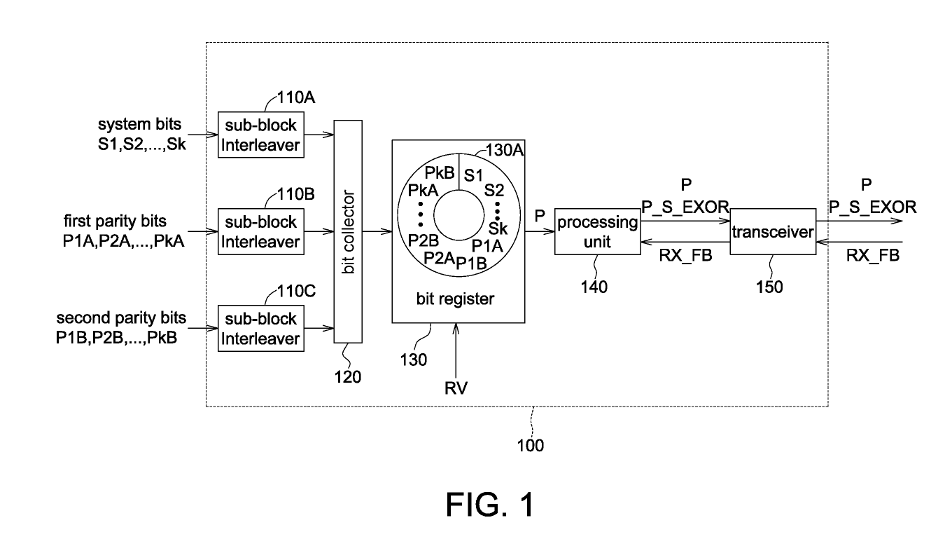

FIG. 1 is a functional block diagram of a wireless communication device according to an embodiment of the disclosure. In following descriptions, the wireless communication device of the embodiments of the disclosure is exemplarily used in hybrid automatic repeat request (HARQ). As indicated in FIG. 1, the wireless communication device 100 of an embodiment of the disclosure includes sub-block interleavers 110A-110C, a bit collector 120, a bit register 130, a processing unit 140 and a transceiver 150. The sub-block interleavers 110A-110C, the bit collector 120 and the processing unit 140 may be implemented as hardware, software or a combination thereof. Basically, the bit register 130 and the transceiver 150 are implemented as hardware.

After the sub-block interleaver 110A performs interleaving on system bits S1, S2 . . . SK (K is a positive integer), the sub-block interleaver 110A transmits interleaved system bits S1, S2 . . . SK to the bit collector 120. After the sub-block interleaver 110B performs interleaving on first parity bits P1A, P2A . . . PKA, the sub-block interleaver 110B transmits interleaved first parity bits P1A, P2A . . . PKA to the bit collector 120. After the sub-block interleaver 110C performs interleaving on second parity bits P1B, P2B . . . PKB, the sub-block interleaver 110C transmits interleaved second parity bits P1B, P2B . . . PKB to the bit collector 120. The first parity bits P1A, P2A . . . PKA are obtained by performing parity on the system bits S1, S2 . . . SK. Similarly, the second parity bits P1B, P2B . . . PKB are obtained by performing parity on the system bits S1, S2 . . . SK.

The bit collector 120 receives the system bits S1, S2, . . . SK, the first parity bits P1A, P2A, . . . PKA and the second parity bits P1B, P2B, . . . PKB from the sub-block interleavers 110A-110C. The bit collector 120 sorts the received system bits S1, S2, . . . SK, the first parity bits P1A, P2A, . . . PKA and the second parity bits P1B, P2B, . . . PKB and transmits the sorted system bits S1, S2, . . . SK, the sorted first parity bits P1A, P2A, . . . PKA and the sorted second parity bits P1B, P2B, . . . PKB to the bit register 130.

Here, the bit register 130 at least includes a circular buffer 130A, but the disclosure is not limited thereto. Arrangement of data registered in the circular buffer 130A is indicated in FIG. 1, but the disclosure is not limited thereto. Data registered in the circular buffer 130A has the following sequence: the system bits S1, S2 . . . SK and the parity bits P1A, P1B, P2A, P2B . . . PKA and PKB. The circular buffer 130A is controlled by a redundancy version signal RV. For example, data stored in the circular buffer 130A is divided into 4 segments. According to the redundancy version signal RV, the circular buffer 130A transmits one of the segments of the registered data as a packet P. The circular buffer 130A transmits the packet P to the processing unit 140. For example, when the redundancy version signal RV=1, the circular buffer 130A transmits the first segment; when the redundancy version signal RV=2, the circular buffer 130A transmits the second segment, and the rest can be obtained by the same analogy. That is, the circular buffer 130A generates an original packet data according to a to-be-transmitted data.

The processing unit 140 receives the packet P (also referred as original packet data) from the bit register 130 (the circular buffer 130A), and further performs cyclic shift on the received packet P to generate a shift packet P_S (not illustrated; also referred as a first shifted data). The processing unit 140 performs a logic operation, such as an exclusive OR logic operation (EXOR), on the packet P and the shift packet P_S to generate a packet P_S_EXOR (also referred as retransmission packet data). In an embodiment of the disclosure, the “cyclic shift” performed by the processing unit 140 may be common. For example, one bit is removed from one end of the register and then is added to the register via the other end. Exemplarily but not restrictively, taking a 8-bit bit register as an example, when a 2-bit rightward cyclic shift is performed on 8-bit data “23457890” stored in the register, the 8-bit data will become “90234578”.

The transceiver 150 transmits the packet P and/or the packet P_S_EXOR received from the processing unit 140 to the receiving end (not illustrated in FIG. 1). The transceiver 150 also transmits the feedback information RX_FB received from the receiving end to the processing unit 140.

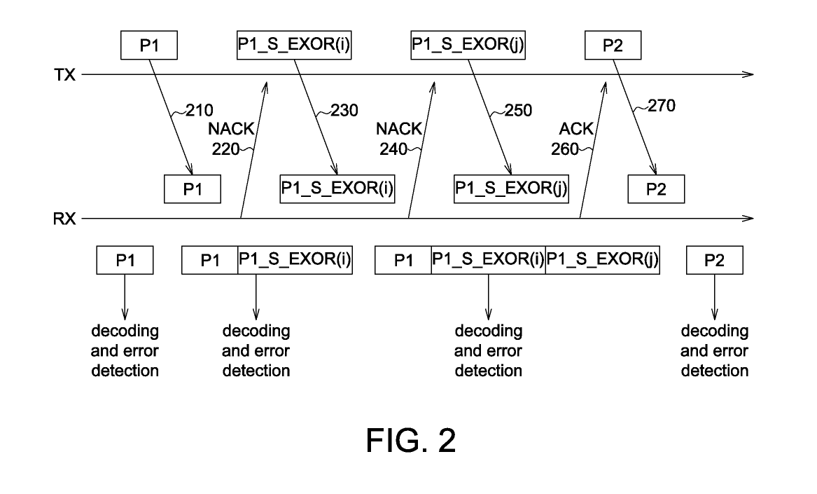

Embodiments of the disclosure disclose several flowcharts of an HARQ process. Referring to FIG. 2, a flowchart of an HARQ process according to an embodiment of the disclosure is shown.

In step 210, the transmitting end TX (such as the wireless communication device 100 of FIG. 1) transmits a packet P1 to the receiving end RX. Here, the transmitting end TX, exemplarily but not restrictively, is a base station supporting the long term evolution (LTE) technique. The receiving end RX, exemplarily but not restrictively, is a user equipment (UE) supporting the LTE technique. The transmitting end TX wirelessly communicates with the receiving end RX. Exemplarily but not restrictively, the packet P1 is the first segment transmitted from the circular buffer 130A (when the redundancy version signal RV=1).

The receiving end RX performs decoding and error detection on the received packet P1. However, due to the factors such as deterioration in channel quality, the receiving end RX may not correctly receive the packet. In step 220, the receiving end RX returns a “negative acknowledgement” signal (NACK) to notify the transmitting end TX that reception fails.

In step 230, the transmitting end TX, after receiving the “negative acknowledgement” signal NACK, transmits a packet P1_S_EXOR (i) to the receiving end RX (“i” is a positive integer, which denotes a rightward cyclic shift parameter). The processing unit 140 performs i-bit rightward cyclic shift on the packet P1 transmitted in step 210 to generate a shift packet P1_S (i) (not illustrated); and performs an EXOR logic operation on the packet P1 and the shift packet P1_S (i) to generate the packet P1_S_EXOR (i). Detailed descriptions of selecting the rightward cyclic shift parameter i, and further notifying the transmitting end TX and the receiving end RX about the currently selected rightward cyclic shift parameter i are disclosed below.

The receiving end RX performs decoding and error detection on the received packets P1 and P1_S_EXOR (i) (according to the rightward cyclic shift parameter i). However, due to the factors such as deterioration in channel quality, the receiving end RX may not successfully receive the packet. In step 240, the receiving end RX returns the “negative acknowledgement” signal NACK to notify the transmitting end TX that reception fails.

In step 250, after receiving the “negative acknowledgement” signal NACK, the transmitting end TX transmits a packet P1_S_EXOR (j) to the receiving end RX (j is a positive integer, which denotes a rightward cyclic shift parameter, and i#j). In response to NACK, the processing unit 140 performs a j-bit rightward cyclic shift on the packet P1 (the packet transmitted in step 210) to generate a shift packet P1_S (j) (not illustrated); and, the processing unit 140 performs an EXOR logic operation on the packet P1 and the shift packet P1_S (j) to generate the packet P1_S_EXOR (j).

The receiving end RX performs decoding and error detection on the received packets P1, P1_S_EXOR (i) and P1_S_EXOR (j) (according to the rightward cyclic shift parameters i and j).

In step 260, if the receiving end RX successfully receives the packet transmitted from the transmitting end TX, the receiving end RX returns an “acknowledgement” signal ACK to the transmitting end TX. In step 270, the transmitting end TX, after receiving the “acknowledgement” signal ACK, transmits a packet P2, such as the second segment transmitted from the circular buffer 130A (when the redundancy version signal RV=2), to the receiving end RX. The rest can be obtained by analogy.

In the specification of the disclosure, the transmitted packets P1_S_EXOR (i) and P1_S_EXOR (j) may can be regarded as a retransmission of the packet P1. This is because, as for the receiving end RX, data obtained by successfully decoding and error detection on the packets P1_S_EXOR (i) and P1_S_EXOR (j) are equivalent to data obtained by successfully decoding and error detection on the packet P1.

Detailed descriptions of selecting the rightward cyclic shift parameter (i or j) according to an embodiment of the disclosure are disclosed below. Refer to Table 1, a relationship between the rightward cyclic shift parameter and the minimum distance parameter dmin is illustrated. Detailed descriptions of obtaining a minimum distance dmin from the packet P_S_EXOR are well-known to a person ordinarily skilled in the art, and therefore are omitted here.

TABLE 1

| “i” | dmin |
|---|---|
| 33 | 42 |
| 34 | 43 |
| 35 | 43 |
| 36 | 40 |
| 37 | 45 |
| 38 | 45 |
| 39 | 44 |
| 40 | 45 |
| 41 | 45 |
| 42 | 45 |
| 43 | 45 |
| 44 | 45 |
| 45 | 45 |
| 46 | 45 |
| 47 | 45 |
| 48 | 26 |
| 49 | 45 |
| 50 | 45 |
| 51 | 45 |
| 52 | 45 |
| 53 | 45 |
| 54 | 45 |
| 55 | 45 |
| 56 | 45 |
| 57 | 44 |
| 58 | 45 |
| 59 | 45 |
| 60 | 40 |
| 61 | 43 |
| 62 | 43 |

In selecting a rightward cyclic shift parameter i (or j), basically, the rightward cyclic shift parameter i (or j) corresponding to the largest minimum distance dmin is selected first. Let Table 1 be taken for example. When the largest minimum distance dmin is 45, basically, the rightward cyclic shift parameter i (or j) of 37, 38, 40, 41, 42 . . . 59 (which are corresponding to the largest minimum distance dmin of 45) will be selected. If all rightward cyclic shift parameter i (or j) corresponding to the largest minimum distance dmin (45) had been selected, then the rightward cyclic shift parameter i (or j) (39 or 57) corresponding to the second largest minimum distance dmin (44) is selected. The rest can be obtained by the same analogy.

Let the flowchart of FIG. 2 be taken for example. In step 230, the selected rightward cyclic shift parameter i could be 37. In step 250, the selected rightward cyclic shift parameter j could be 38.

Detailed descriptions of notifying the transmitting end TX and the receiving end RX about the currently selected rightward cyclic shift parameter (i and j) according to an embodiment of the disclosure are disclosed below. Some implementations for notifying the transmitting end TX and the receiving end RX about the currently selected shift parameter (i and j) are exemplified below. However, the disclosure is not limited thereto.

First Implementation: Pre-Definition

In the first implementation, the transmitting end TX and the receiving end RX both obtain the pre-defined sequence of cyclic shift parameters in selecting rightward cyclic shift parameters. Let Table 1 be taken for example. The transmitting end TX and the receiving end RX both know that the rightward cyclic shift parameter selected in the first round is 37, the rightward cyclic shift parameter selected in the second round is 38, the rightward cyclic shift parameter selected in the third round is 40, and the rest can be obtained by the same analogy.

Second Implementation: The Transmitting End TX Notifying the Receiving End RX about Rightward Cyclic Shift Parameter Selected in the Current Round.

In the second implementation, the transmitting end TX notifies the receiving end RX about the currently selected rightward cyclic shift parameter. That is, the receiving end RX does not have to know the rightward cyclic shift parameter in advance. In a possible embodiment of the disclosure, when the transmitting end TX notifies the receiving end RX about the “rightward cyclic shift parameter”, the “rightward cyclic shift parameter” may be included in the packet P_S_EXOR. In another possible embodiment of the disclosure, when the transmitting end TX notifies the receiving end RX about the “rightward cyclic shift parameter”, the “rightward cyclic shift parameter” may be independent of the packet P_S_EXOR. These exemplifications are all within the spirit of the disclosure.

Third Implementation: The Receiving End RX Suggesting the to-be-Selected “Rightward Cyclic Shift Parameter” to the Transmitting End TX.

In the third implementation, the receiving end RX suggests a to-be-selected “rightward cyclic shift parameter” to the transmitting end TX. The transmitting end TX, after receiving the to-be-selected “rightward cyclic shift parameter” from the receiving end RX, generates a packet P_S_EXOR according to the suggested “rightward cyclic shift parameter”. Exemplarily but not restrictively, the receiving end RX may suggest a to-be-selected “rightward cyclic shift parameter” to the transmitting end TX based on the signal noise ratio (SNR). That is, the receiving end RX transmits a “cyclic shift parameter selection instruction” to the transmitting end TX.

Other available implementations for notifying the transmitting end TX and the receiving end RX about the currently selected shift parameter are not limited by the above three implementations exemplified above. The disclosure may use other available implementations for notifying the transmitting end TX and the receiving end RX about the selected “rightward cyclic shift parameter”, which is still within the spirit of the disclosure.

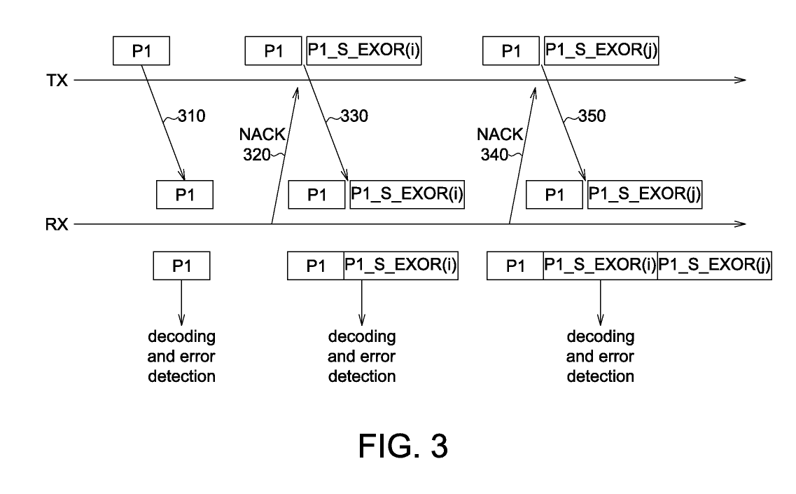

Referring to FIG. 3, a flowchart of an HARQ process according to an embodiment of the disclosure is shown. FIG. 3 is similar to FIG. 2 except that the transmitting end TX, after receiving the “negative acknowledgement” signal NACK from the receiving end RX, transmits a packet P1 and a packet P1_S_EXOR.

In step 310, the transmitting end TX transmits a packet P1 to the receiving end RX.

The receiving end RX performs decoding and error detection on the received packet P1. However, the receiving end RX does not successfully transmit the packets due to the factors such as deterioration in channel quality. In step 320, the receiving end RX returns a “negative acknowledgement” signal NACK to notify the transmitting end TX that reception fails.

In step 330, the transmitting end TX, after receiving the “negative acknowledgement” signal NACK, transmits a packet P1 and a packet P1_S_EXOR (i) to the receiving end RX.

The receiving end RX performs decoding and error detection on the received packets P1 and P1_S_EXOR (i) (according to the rightward cyclic shift parameter i). However, the receiving end RX does not successfully receive the packets due to the factors such as deterioration in channel quality. In step 340, the receiving end RX returns the “negative acknowledgement” signal NACK to notify the transmitting end TX that reception fails.

In step 350, the transmitting end TX, after receiving the “negative acknowledgement” signal NACK, transmits a packet P1 and a packet P1_S_EXOR (j) to the receiving end RX.

The receiving end RX performs decoding and error detection on the received packets P1, P1_S_EXOR (i) and P1_S_EXOR (j) (according to rightward cyclic shift parameter i and j).

As for the embodiment of FIG. 3, the implementation in selecting the rightward cyclic shift parameter, and in notifying the transmitting end TX and the receiving end RX about the currently selected rightward cyclic shift parameter (i and j) may be identical or similar to FIG. 2, and the details are omitted here.

Also, in the above embodiments illustrated in FIG. 2 and FIG. 3 of the disclosure, the transmitting end TX may use the “acknowledgement” signal ACK or the “negative acknowledgement” signal NACK returned from the receiving end RX as a reference for subsequent transmission.

During the HARQ process illustrated in FIG. 2 and FIG. 3, packet may be modulated in many implementations. For example, in step 230/330, the transmitting end TX may transmit the packets by quadrature phase shift keying (QPSK) or quadrature amplitude modulation (QAM), which are complicated. Suppose the receiving end RX returns a “negative acknowledgement” signal NACK to the transmitting end. Then, in the next step 250/350, the transmitting end TX may transmit the packets by binary phase shift keying (BPSK), which is easier. Thus, the probability of successfully receiving data by the receiving end RX may be increased.

In terms of the HARQ process illustrated in FIG. 2 and FIG. 3, the embodiments of the disclosure advantageously have high reliability. The reliability is high because by performing cyclic shift and EXOR operation on the packets, the error tolerance rate of the packets is increased.

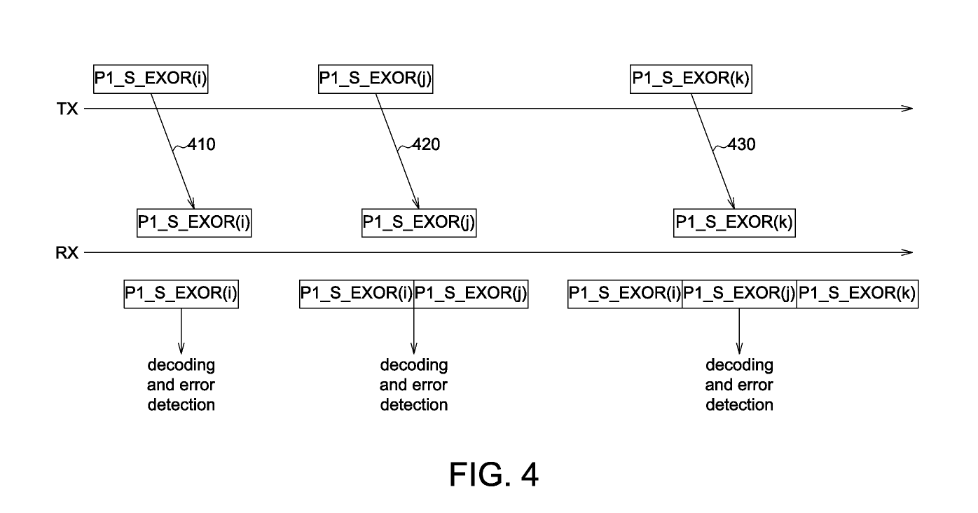

Referring to FIG. 4, a flowchart of an HARQ process according to an embodiment of the disclosure is shown.

In step 410, the transmitting end TX (such as the wireless communication device 100 of FIG. 1) transmits a packet P1_S_EXOR (i) to the receiving end RX. The packet P1 may be realized by such as a first segment data from the circular buffer 130A when the redundancy version signal RV=1. The definition of the packet P1_S_EXOR (i) is as disclosed above. The receiving end RX performs decoding and error detection on the received packet P1.

In step 420, no matter whether the receiving end RX successfully receive the packet or not and no matter the transmitting end TX receives any return signal (ACK/NACK) from the receiving end RX or not, the transmitting end TX decides to transmit a packet P1_S_EXOR (j) to the receiving end RX. The receiving end RX performs decoding and error detection on the received packet P1_S_EXOR (i) and packet P1_S_EXOR (j).

In step 430, no matter whether the receiving end RX successfully receive the packet or not and no matter the transmitting end TX receives any return signal (ACK/NACK) from the receiving end RX or not, the transmitting end TX decides to transmit a packet P1_S_EXOR (k) to the receiving end RX (k is a positive integer, which denotes a rightward cyclic shift parameter, k≠i≠j). The receiving end RX performs decoding and error detection on the received packets P1_S_EXOR (i), P1_S_EXOR (j) and P1_S_EXOR (k).

In FIG. 4, the implementation for selecting the rightward cyclic shift parameter, and for notifying the transmitting end TX and the receiving end RX about the currently selected rightward cyclic shift parameter (i, j and k) may be identical or similar to FIG. 2, and the details are omitted here.

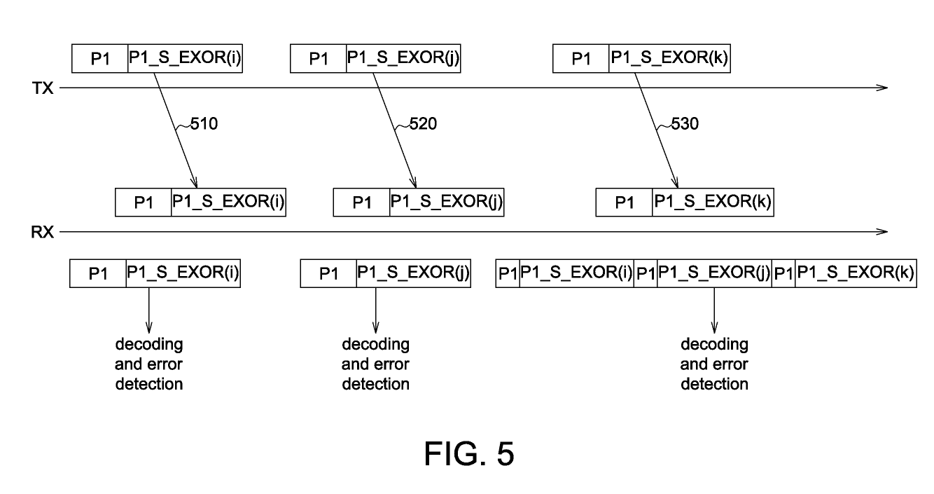

Referring to FIG. 5, a flowchart of an HARQ process according to an embodiment of the disclosure is shown.

In step 510, the transmitting end TX (such as the wireless communication device 100 of FIG. 1) transmits a packet P1 and a packet P1_S_EXOR (i) to the receiving end RX. The receiving end RX performs decoding and error detection on the received packets P1 and P1_S_EXOR (i).

In step 520, no matter whether the receiving end RX successfully receive the packet or not and no matter the transmitting end TX receives any return signal (ACK/NACK) from the receiving end RX or not, the transmitting end TX decides to transmit next packets P1 and P1_S_EXOR (j) to the receiving end RX. The receiving end RX performs decoding and error detection on the received packets P1, P1_S_EXOR (i) and P1_S_EXOR (j).

In step 530, no matter whether the receiving end RX successfully receive the packet or not and no matter the transmitting end TX receives any return signal (ACK/NACK) from the receiving end RX or not, the transmitting end TX decides to transmit next packets P1 and P1_S_EXOR (k) to the receiving end RX. The receiving end RX performs decoding and error detection on the received packet P1, packets P1_S_EXOR (i), P1_S_EXOR (j) and P1_S_EXOR (k).

In FIG. 5, the implementations for selecting the rightward cyclic shift parameter, and for notifying the transmitting end TX and the receiving end RX about the currently selected rightward cyclic shift parameter (i, j and k) may be identical or similar to FIG. 2, and the details are omitted here.

In FIG. 5, the transmitting end TX, after transmitting data for a pre-determined number of times (for example, 8 times), may pause and wait to receive a return signal ACK/NACK form the receiving end RX.

To put it in greater details, after transmitting data for a pre-determined number of times, the transmitting end TX may pause and wait to receive a return signal from the receiving end RX. If the first return signal received by the receiving end RX from the transmitting end is an “acknowledgement” signal ACK, this indicates that the first packet P1 transmitted from the transmitting end TX has been successfully received by the receiving end RX, and the transmitting end TX does not need to retransmit the packet P1 in subsequent process. Conversely, if the first return signal received by the receiving end RX from the transmitting end is a “negative acknowledgement” signal NACK, which indicates that the first packet P1 transmitted from the transmitting end TX cannot be successfully received by the receiving end RX, the transmitting end TX needs to retransmit the packet P1 in subsequent process.

In terms of the HARQ process illustrated in FIG. 4 and FIG. 5, the embodiments of the disclosure advantageously have low delay and high reliability. The delay is low because the transmitting end TX transmits the next packet without having to wait to receive a return signal from the receiving end RX. The reliability is high because by performing cyclic shift and EXOR operation on the packets, the error tolerance rate of the packets is increased.

The embodiments of the disclosure may be used in physical downlink control channel (PDCCH), physical uplink control channel (PUCCH), physical sidelink control channel (PSCCH) to enrich the content of the return signal of the receiving end.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A wireless communication method, comprising:
generating an original packet data according to a to-be-transmitted data;
transmitting the original packet data;
performing a first cyclic shift operation on the original packet data to generate a first shifted data;
performing an EXOR logic operation on the original packet data and the first shifted data to generate a first retransmission packet data; and
transmitting the first retransmission packet data.

2. The wireless communication method according to claim 1, wherein the step of performing the first cyclic shift operation on the original packet data is executed in response to a negative acknowledgement signal (NACK).

3. The wireless communication method according to claim 1, wherein
a first cyclic shift parameter is selected according to a minimum distance to perform the first cyclic shift operation.

4. The wireless communication method according to claim 3, further comprising:
after transmitting the first retransmission packet data, in response to a negative acknowledgement signal (NACK),
performing a second cyclic shift operation on the original packet data according to a second cyclic shift parameter to generate a second shifted data and performing an EXOR logic operation on the original packet data and the second shifted data to generate a second retransmission packet data, wherein the second cyclic shift parameter is selected according to the minimum distance; and
transmitting the second retransmission packet data.

5. The wireless communication method according to claim 3, further comprising:
performing a second cyclic shift operation on the original packet data according to a second cyclic shift parameter to generate a second shifted data, and performing the EXOR logic operation on the original packet data and the second shifted data to generate a second retransmission packet data, wherein the first cyclic shift parameter and the second cyclic shift parameter are selected according to a minimum distance; and
transmitting the second retransmission packet data.

6. The wireless communication method according to claim 3, further comprising:
performing a second cyclic shift operation on the original packet data according to a second cyclic shift parameter to generate a second shifted data, and performing the EXOR logic operation on the original packet data and the second shifted data to generate a second retransmission packet data, wherein the first cyclic shift parameter and the second cyclic shift parameter are selected according to a minimum distance; and
transmitting the original packet data and the second retransmission packet data.

7. The wireless communication method according to claim 3, further comprising:
selecting the first cyclic shift parameter according to a pre-defined sequence of cyclic shift parameters.

8. The wireless communication method according to claim 3, further comprising:
transmitting the selected first cyclic shift parameter.

9. The wireless communication method according to claim 3, further comprising:
selecting the first cyclic shift parameter according to a cyclic shift parameter selection instruction transmitted from a receiving end.

10. A wireless communication device, comprising:
a bit register for temporarily storing a to-be-transmitted data;
a processing unit, coupled to the bit register, for generating an original packet data according to a to-be-transmitted data, performing a first cyclic shift operation on the original packet data to generate a first shifted data, and performing an EXOR logic operation on the original packet data and the first shifted data to generate a first retransmission packet data; and
a transceiver for transmitting the original packet data and the first retransmission packet data.

11. The wireless communication device according to claim 10, wherein the processing unit, in response to a negative acknowledgement signal (NACK), performs the first cyclic shift operation on the original packet data.

12. The wireless communication device according to claim 10, wherein
the processing unit selects a first cyclic shift parameter according to a minimum distance to perform the first cyclic shift operation.

13. The wireless communication device according to claim 12, wherein after the transceiver transmits the first retransmission packet data, in response to a negative acknowledgement signal (NACK) received by the transceiver,
the processing unit performs a second cyclic shift operation on the original packet data according to a second cyclic shift parameter to generate a second shifted data and performs the EXOR logic operation on the original packet data and the second shifted data to generate a second retransmission packet data, wherein the second cyclic shift parameter is selected according to the minimum distance; and
the transceiver transmits the second retransmission packet data.

14. The wireless communication device according to claim 12, wherein
the processing unit performs a second cyclic shift operation on the original packet data according to a second cyclic shift parameter to generate a second shifted data, and performs the EXOR logic operation on the original packet data and the second shifted data to generate a second retransmission packet data, wherein the first cyclic shift parameter and the second cyclic shift parameter are selected according to a minimum distance; and
the transceiver transmits the second retransmission packet data.

15. The wireless communication device according to claim 12, wherein
the processing unit performs a second cyclic shift operation on the original packet data according to a second cyclic shift parameter to generate a second shifted data, and performs the EXOR logic operation on the original packet data and the second shifted data to generate a second retransmission packet data, wherein the first cyclic shift parameter and the second cyclic shift parameter are selected according to a minimum distance; and
the transceiver transmits the original packet data and the second retransmission packet data.

16. The wireless communication device according to claim 12, wherein
the processing unit selects the first cyclic shift parameter according to a pre-defined sequence of cyclic shift parameters.

17. The wireless communication device according to claim 12, wherein
the transceiver transmits the selected first cyclic shift parameter.

18. The wireless communication device according to claim 12, wherein
the processing unit selects the first cyclic shift parameter according to a cyclic shift parameter selection instruction which is sent from a receiving end and received by the transceiver.

19. A wireless communication system, comprising:
a transmitting end device comprising a bit register temporarily storing a to-be-transmitted data, wherein the transmitting end device generates an original packet data according to the to-be-transmitted data, performs a first cyclic shift operation on the original packet data to generate a first shifted data, performs an EXOR logic operation on the original packet data and the first shifted data to generate a first retransmission packet data, and transmits the original packet data and the first retransmission packet data; and
a receiving end device, wirelessly communicating with the transmitting end device, for receiving the original packet data and the first retransmission packet data.

20. The wireless communication system according to claim 19, wherein in response to a negative acknowledgement signal (NACK) transmitted from the receiving end device, the transmitting end device performs the first cyclic shift operation on the original packet data.

21. The wireless communication system according to claim 19, wherein
the transmitting end device selects a first cyclic shift parameter according to a minimum distance to perform the first cyclic shift operation.

22. The wireless communication system according to claim 21, wherein
after the transmitting end device transmits the first retransmission packet data, in response to a negative acknowledgement signal (NACK) transmitted from the receiving end device,
the transmitting end device performs a second cyclic shift operation on the original packet data according to a second cyclic shift parameter to generate a second shifted data, and performs an EXOR logic operation on the original packet data and the second shifted data to generate a second retransmission packet data, wherein the second cyclic shift parameter is selected according to the minimum distance; and
the transmitting end device transmits the second retransmission packet data.

23. The wireless communication system according to claim 21, wherein
the transmitting end device performs a second cyclic shift operation on the original packet data according to a second cyclic shift parameter to generate a second shifted data, and performs the EXOR logic operation on the original packet data and the second shifted data to generate a second retransmission packet data, wherein the first cyclic shift parameter and the second cyclic shift parameter are selected according to a minimum distance; and
the transmitting end device transmits the second retransmission packet data.

24. The wireless communication system according to claim 21, wherein
the transmitting end device performs a second cyclic shift operation on the original packet data according to a second cyclic shift parameter to generate a second shifted data, and performs the EXOR logic operation on the original packet data and the second shifted data to generate a second retransmission packet data, wherein the first cyclic shift parameter and the second cyclic shift parameter are selected according to a minimum distance; and
the transmitting end device transmits the original packet data and the second retransmission packet data.

25. The wireless communication system according to claim 21, wherein
the transmitting end device selects the first cyclic shift parameter according to a pre-defined sequence of cyclic shift parameters.

26. The wireless communication system according to claim 21, wherein
the transmitting end device transmits the selected first cyclic shift parameter.

27. The wireless communication system according to claim 21, wherein
the transmitting end device selects the first cyclic shift parameter according to a cyclic shift parameter selection instruction from the receiving end device.
